(19) United States
(12) Patent Application Publication
(10) Pub. No.: US 2010/0292961 A1
(43) Pub. Date: Nov. 18, 2010

(54) Wireless tracking device for tracking appliance usage and modifying user behavior

(76) Inventor: David Moss, Tucson, AZ (US)

Correspondence Address: David Moss, #1210, 5051 N. Sabino Canyon, Tucson, AZ, 85750, US

(21) Appl. No.: 12/454,315

(22) Filed: May 15, 2009

(51) Int. Cl. G06F 15/00

(52) U.S. Cl. 702/188

(57) ABSTRACT

A wireless tracking device for monitoring usage patterns and power consumption of appliances such as a refrigerator. The power consumption is monitored by the use of new and innovative wireless tracking device that is placed by a user inside the appliance while it is operational. Appliance usage pattern information and power consumption information is communicated by the wireless tracking device and is collected by an intelligent power hub (and in some embodiments, an energy pump device, an intelligent power meter or a collector device). User behavior is modified by recommending approaches to cut power consumption by the appliances thereby providing savings and reducing the cost of operation.

### CROSS REFERENCES TO RELATED APPLICATIONS

The present patent application is related to and makes reference to a co-pending application, entitled “A MONITORING SYSTEM FOR COLLECTION AND DISTRIBUTION OF A POWER CONSUMPTION INFORMATION”, filed on Mar. 31, 2009, docket number GWPP2009U1.

The present patent application is also related to and makes reference to a co-pending application, entitled “WEB BASED MONITORING, MANAGEMENT AND CONTEST BASED ON COLLECTED POWER CONSUMPTION DATA”, filed on Mar. 31, 2009, docket number GWPP2009U2.

The complete subject matter of the two above-referenced United States Patent Applications is hereby incorporated herein by reference, in their entirety. The present patent application and the above-referenced United States Patent Applications share the same inventors and have the same filing date.

### BACKGROUND

1. Technical Field

The present invention relates generally to energy saving and power consumption monitoring and particularly to a wireless device that can be located inside an appliance, such as a refrigerator, that monitors usage patterns and correlates that to power consumption.

2. Related Art

Power consuming appliances are becoming ubiquitous. People use electrical tools and appliances all over their residences. Some electrical appliances are turned on and seldom turned off, even when the user does not need the appliance or make use of it. Most people living in a modern house have a TV, a refrigerator, a washing machine, a washer, a dryer, a heating system, an air conditioner, etc. Most of these devices consume a lot of power when they are plugged into power outlets, some even when they are not being used.

Every day people use a lot of electricity for running appliances such as a refrigerator, but they don't know how much power these appliances consume. The doors of refrigerators are opened several times a day, and often for extended durations, thereby causing the refrigerator to use more power to keep things cool. Quite often the temperature settings on the refrigerator are inappropriate—set too high or set too low.

Unfortunately, despite widespread acceptance of green house effects and despite rise in the price of crude oil, people have not been provided with effective power saving technologies. People are being encouraged to turn off light bulbs when they are not in a room. Some appliance can be turned off if they are not being used. However, turning off a refrigerator when a user is travelling it is not an option as food stored in the refrigerator is likely to get spoiled when it is turned off. Thus, effective power saving mechanisms are lacking for appliances such as refrigerators.

Often people do not know how much power they can save by following all the typical power saving recommendations. Well meaning individuals have no idea how effective all their power saving efforts has been. Even if one were to use green electrical appliances, one does not know if one can be more effective in saving power by adopting better usage patterns.

There is a problem educating users on effective power management techniques that saves them money by reducing power consumption of their refrigerators and other appliances. Quite often, these individuals who have lowered their electric bills do not know how much individual appliances have contributed towards the savings in energy bills.

In view of the foregoing considerations, it is clear that there is a need for an improved system and method for measuring power consumption and monitoring power usage.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a monitoring system comprising a wireless tracking device that is placed/used inside an appliance to monitor the usage pattern of the appliance and collect data that is likely to influence user behavior.

FIG. 2 is a flow chart of an exemplary operation of the monitoring system that comprises a wireless tracking device placed/located inside a monitored appliance, such as a refrigerator, as the monitoring system monitors power usage by the appliances.

FIG. 3 is a perspective block diagram of a monitoring system that monitors energy consumption by and user behavior for a plurality of appliances, all located in a premises that comprises a powerline and power sockets.

FIG. 4 is a flow chart of an exemplary operation of the wireless monitoring device that is built in accordance with the present invention.

### DETAILED DESCRIPTION OF THE DRAWINGS

The present invention provides an elegant means of monitoring usage patterns and power consumption of appliances such as a refrigerator. The power consumption is monitored by the use of new and innovative wireless tracking device that is placed by a user inside the appliance while it is operational. Appliance usage pattern information and power consumption information is communicated by the wireless tracking device and is collected by an intelligent power hub (and in some embodiments, an energy pump device, an intelligent power meter or a collector device). User behavior is modified by recommending approaches to cut power consumption by the appliances thereby providing savings and reducing the cost of operation.

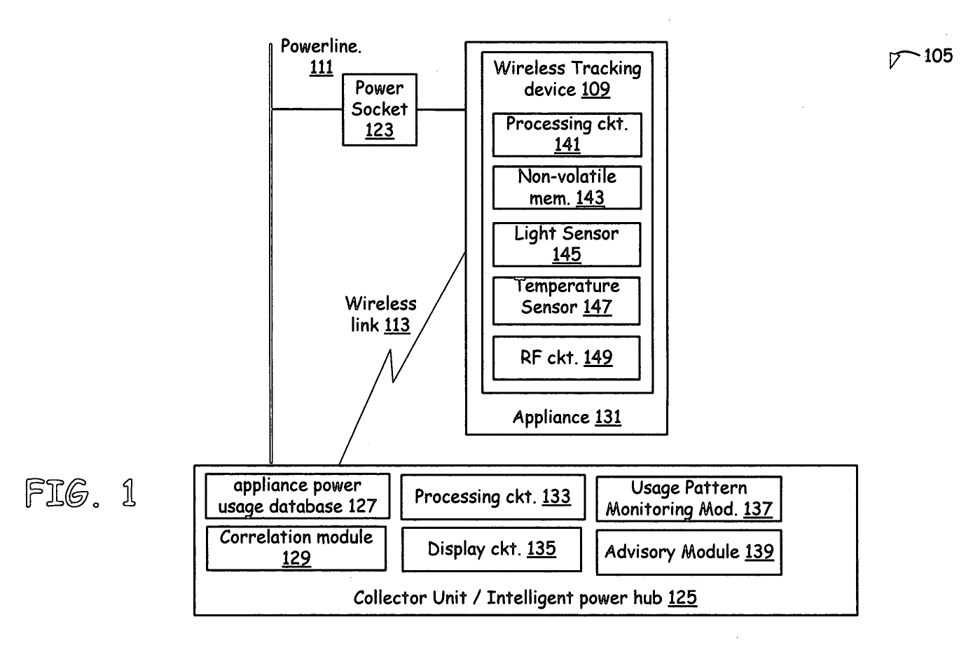

FIG. 1 is a monitoring system 105 comprising a wireless tracking device 109 that is placed/used inside an appliance 131 to monitor the usage pattern of the appliance and collect data that is likely to influence user behavior. The wireless tracking device 109 is communicatively coupled via the wireless link 113 to a collector unit/an intelligent power hub 125. The wireless tracking device 109 is tracks user behavior as the user uses the appliance 131. For example, it keeps track of the number the times the appliance is used, the duration of its usage etc. It employs sensors to determine various measurements and the occurrence of events. The appliance 151315 is plugged into a powerline 111 via an intelligent power socket 123 that is capable of measuring power consumption by the appliance 131.

The monitoring device 109 comprises a processing circuitry 141, a non-volatile memory 143, a light sensor 145, a temperature sensor 147 and an RF circuitry 149. The monitoring device 109 communicates data collected by the light sensor 145 and the temperature sensor 147 to the collector unit/intelligent power hub 125.

The collector unit/intelligent power hub 125 comprises an appliance power usage database 127, a processing circuitry 133, a display circuitry 135, a correlation module 129 a usage pattern monitoring module 137 and an advisory module 139. The wireless tracking device 109 communicates data collected by the sensors 145, 147 and appliance usage information for the appliance 131 to the collector unit/intelligent power hub 125 that is stored for processing in the appliance power usage database 127.

The collector unit/intelligent power hub 125 employs a processing circuitry 137 to process sensor data and appliance usage data received from the wireless tracking device 10. It employs the display circuitry 139 for displaying a list comprising the appliance details and correlation to data collected from the wireless tracking device 109.

In the collector unit/intelligent power hub 125, usage information reported for the appliance 131 is received from the wireless tracking device 109 and power consumption information for the appliance 131 is received from the power socket 123. The collector unit/intelligent power hub 125 presents a user with an overall power usage data that is displayed for the user via the display circuitry 135. The overall power usage data presented is based on power usage information collected and computed over time, user pattern of usage of the appliance 131, sensor data on temperature and light that is monitored and tracked, etc.

In one embodiment, the appliance 131 is a refrigerator and the wireless device 109 is placed inside the refrigerator 131, and tracks usage and energy consumption of the refrigerator 131. It facilitates modification of user behavior, for example, by reminding the user to keep the refrigerator 131 door shut as much as possible. It tracks when a refrigerator/freezer door is opened, it keeps track of how many times it has been opened in a day, how long it has been opened for each time, as well as other parameters such as the temperature inside the refrigerator 131 before and after the refrigerator 131 is opened each time. The collector unit/intelligent power hub 125, using the correlation module 129, correlates the number of times and the duration the refrigerator 131 door has been opened with the energy consumption of the refrigerator 131 (which is being monitored by power socket 123, for example, plugged into the wall socket for the powerline 111). It determines an estimate of how much it costs the user each time the user opens the refrigerator 131 door. It also makes recommendations about the appropriate temperature setting of the refrigerator 131, whether it needs to be turned up or down, which would otherwise normally be set by the user only by guess work.

The wireless tracking device 109 communicates using the RF circuitry 149 (for example an RF radio). It employs on-board sensors (one or more) to detect/measure light and temperature. It also has a speaker/buzzer to produce sound. wireless tracking device 109 is typically a small, unobtrusive, battery powered unit. The RF circuitry 149 allows it to communicate with an existing wireless infrastructure that is monitoring appliance energy consumption, such as the collector unit/intelligent power hub 125.

The wireless tracking device 109 is placed anywhere inside an appliance 131. For example, when the appliance 131 is a refrigerator 131, it can be placed anywhere inside the refrigerator 131, such as the refrigeration section or the freezer section. The wireless tracking device 109 enters an extremely low power state with every component virtually turned off, and it periodically checks the light sensor 145 for changes. Using the light sensor, it waits for the light reading by the light sensor 145 to cross a threshold, and then verifies with several readings. When it determines that the refrigerator 131 door is opened after a sample or a set of several samples is determined to exceed a light threshold value, it tracks how long the refrigerator door is open and the temperature inside before and after the door is opened or closed.

In one embodiment, the light sensor is based on a photo-diode and the wireless tracking device 109 uses the photodiode sensor to “see” when there is light around it, which will only happen when the refrigerator door has been opened. It also increments a variable in its non-volatile memory 143 to keep track of how many times the refrigerator 131 has been opened. It adds hysteresis to prevent it from falsely determining the door has been opened or closed too rapidly. At the same time it alerts the collector unit/intelligent power hub 125 (which behaves as the main gateway for the wireless monitoring network) that the refrigerator 131 door is open. The wireless tracking device 109 starts a timer to track how much time the door of the refrigerator 131 has been kept open. If the door is left open for a relatively long period of time (10 seconds for example), it alerts the consumer through audible sounds. For example, the wireless tracking device 109 beeps at the user or plays a preset audio message. In one related embodiment, it lets a user select or set a pre-record customized audio message that it plays back to remind the user to close the refrigerator door when it is kept open, or to change the temperature setting when necessary. Such audio could be, for example, a sentence suggesting to the user “Close the refrigerator door! It's getting hot in here!” This helps in reminding the user to close the door and also helps in modifying their behavior.

Periodically, the wireless tracking device 109 reports the temperature inside the refrigerator/freezer 131. It does this throughout the day, or when the refrigerator/freezer 131 reaches a high or low threshold in temperature. In one related embodiment, it reports only when the refrigerator/freezer 131 door has been kept open for a long time. The wireless tracking device 109 reports (from inside refrigerator/freezer 131) explicit temperature measurements in units of Celsius or Fahrenheit, which helps the user know whether the refrigerator is too hot or cold. Thus, it helps eliminate the guess work in determining the refrigerator/freezer temperatures.

The wireless device 109 thus helps a user determine if the user can save energy on his refrigerator 131 simply by filling it with more items which will increase its thermal mass and prevent the refrigerator 131 from having to work as hard because there is less warm air that needs to be cooled each time the user opens the door of the refrigerator 131. The wireless device 109 also alerts the collector unit/intelligent power hub 125 when its batteries might be running low so that the user can replace the batteries.

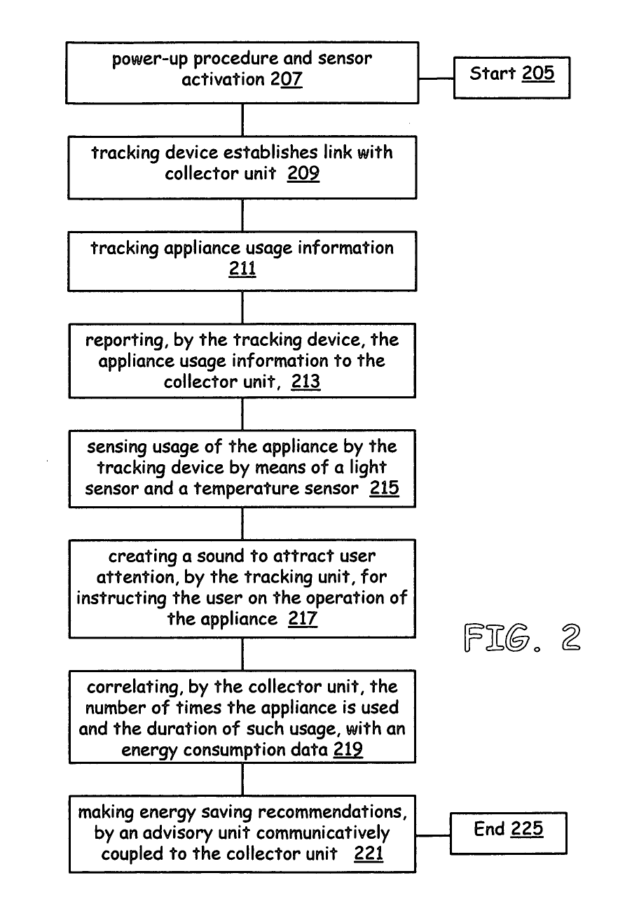

FIG. 2 is a flow chart of an exemplary operation of the monitoring system 105 that comprises a wireless tracking device 109 placed/located inside a monitored appliance 131, such as a refrigerator, as the monitoring system 105 monitors power usage by the appliances 131. At a start block 205, the processing starts when the wireless tracking device 109 is placed inside the appliance 131. Then, at a next block 207, the power-up procedure for the wireless tracking device 109 is initiated and the sensors wireless tracking device 109, such as a light sensor 145 and a temperature sensor 147, are activated.

Then, at a next block 209, the wireless tracking device 109 establishes a communication link with the collector unit/intelligent power hub 125. Such communicative coupling occurs over means such as Bluetooth or WiFi based protocols. Then, at a next block 211, tracking of appliance usage occurs, such as tracking of opening and closing of doors, activation or deactivation of different features or components of the appliance, etc.

At a next block 213, reporting by the wireless tracking device 109 occurs. Such reporting involves reporting sensor data collected by various sensors, reporting user behavior such as the frequency with which a user uses the appliance 131, the duration of each usage, etc. In the case of a refrigerator, reporting comprises data on the numbers of times the doors of the refrigerator are opened, the duration for which the doors are kept open, the temperature before and after the opening of the refrigerator doors, etc. A power usage information for the appliance 131 that is collected from the associated power socket 123 also occurs simultaneously, in one related embodiment.

Then at a next block 215, sensing usage of the appliance 131 by the wireless tracking device 109 continues, wherein the wireless tracking device 109 employs the light sensor 145 and the temperature sensor 147 for detecting user behavior and for making measurements. At a next block 217, when the wireless tracking device 109 detects that an appliance is being used inappropriately, such as keeping the door of a refrigerator open for a long time, it attracts user attention by creating a sound, thereby instructing the user on the proper operation of the appliance.

Then, at a next block 219, the collector unit correlates data collected, employing the correlation module 129. For example such correlation involves the number of times the appliance is used and the duration of such usage, with an energy consumption data gathered from a different source such as the power socket 123 (that reports energy consumed by the appliance 131). At a next block 221, the user behavior modification is attempted by making energy saving recommendations. Such recommendations are generated by an advisory unit communicatively coupled to the collector unit/intelligent power hub 125 (or one that is part of the collector unit/intelligent power hub 125, such as the advisory module 139). The operation then terminates at the end block 225.

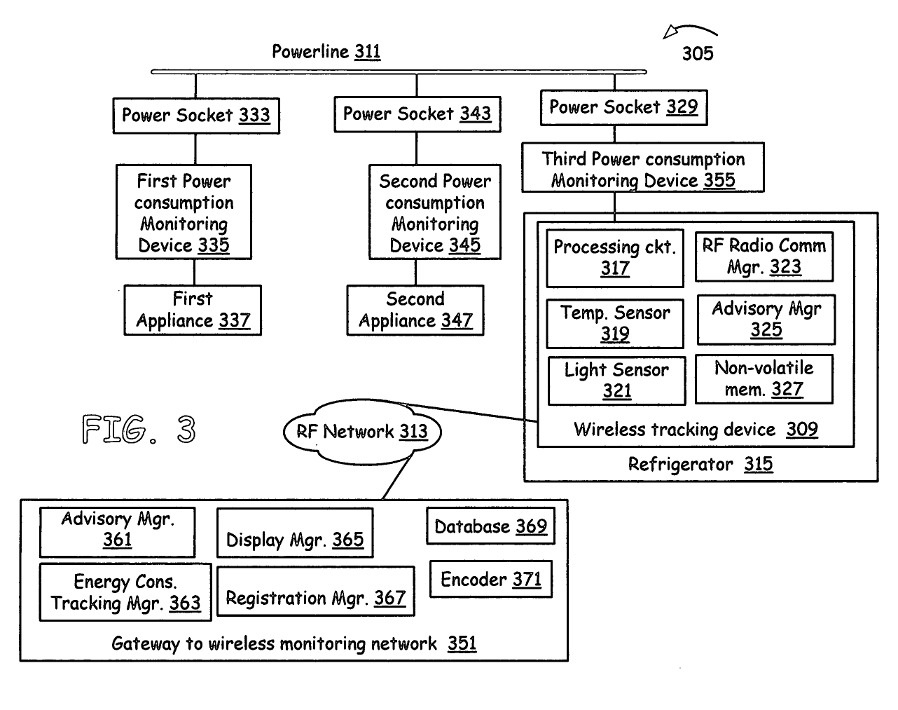

FIG. 3 is a perspective block diagram of a monitoring system 305 that monitors energy consumption by and user behavior for a plurality of appliances 337, 347, 315 all located in a premises, that comprises a powerline 311 and power sockets 333, 343, 329. In particular, the power socket 329 is electrically coupled to the powerline 311 in the premises and the refrigerator 315 (appliance) obtains electrical power from the powerline 311 via the power socket 329 and the third power consumption monitoring device 355. The refrigerator 315 (appliance) is plugged into the third power consumption monitoring device 355 which in turn is plugged into the power socket 329.

The refrigerator 315 has a wireless tracking device 315 that tracks user behavior as the user opens and closes refrigerator doors (doors to the refrigeration section and the freezer section). The monitoring system 305 comprises a gateway to wireless monitoring network 351 with which the wireless tracking device 309 interacts, to receive monitoring/tracking instructions and to report data collected. The power consumed by the refrigerator 315 is reported by the third power consumption monitoring device 355.

Later, the gateway 351 discovers the presence of the power consumption monitoring devices 335, 345, 355, after those power consumption monitoring devices are plugged in to the powerline 311 via appropriate power sockets 333, 343, 329. For example, when the power consumption monitoring device 329 is plugged in to the powerline 311, the gateway 351 is already powered up and ready to discover new power consumption monitoring devices. Communication between the wireless tracking device 315 located in the refrigerator 315, and the gateway 351, occurs via the RF network 313. Communication between the power consumption monitoring devices 335, 345, 355 and the gateway 351 occurs either via the RF network 313 (using wireless means) or over the powerline 311 employing powerline communication means (using appropriate protocols for powerline based communications).

The operation of the wireless tracking device 315 is similar to the operation of the wireless tracking device 109 in FIG. 1. The gateway 351 presents an energy saved data, a money saved data and a energy usage model to the user, at least partially based on the user's current daily energy consumption baseline reported by the power consumption monitoring devices 335, 345, 355. It also provides the user a usage profile for the refrigerator 315, and recommends ways to reduce power consumption and thereby reduce cost of operation of the refrigerator 315.

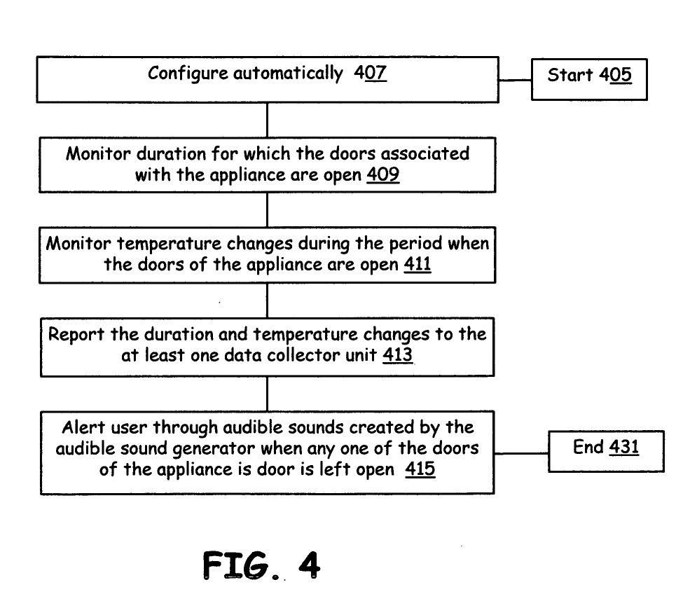

FIG. 4 is a flow chart of an exemplary operation of the wireless monitoring device 309 that is built in accordance with the present invention. At a start block 405, processing starts when the wireless monitoring device 109 is powered up and placed inside a device, such as a refrigerator 315. Then, at a next block 407, using parameters set in non-volatile memory 327, the wireless monitoring device 309 is configured automatically. Such parameters include threshold values for operation of the light sensor 321, parameters for the temperature sensor 319, time duration values for reporting problems, errors etc. The wireless tracking device 309 also acquires communication parameters to communicate automatically with the gateway 351.

Then, at a next block 409, when the door of the refrigerator 315 is determined to be open by the light sensor 321, the wireless tracking device 309 monitors the duration for which the doors associated with the refrigerator 315 are kept open. This applies to the doors appropriate section of the refrigerator where the wireless tracking device 309 is currently placed, such as one of the refrigeration section or the freezer section of the refrigerator 315.

Then, at a next block 409, the wireless tracking device 309 automatically monitors the temperature changes, tracked by the temperature sensor 319, during the period when the doors of the refrigerator are kept open.

Later, at a next block 413, the wireless tracking device 309 reports the duration and temperature changes in the refrigerator 315 to the gateway to the wireless monitoring network 351. Thus, if a door of the refrigerator 315 is being kept open for too long a duration y a user, it will be detected and reported.

Then, at a next block 415, the wireless tracking device 309 alerts the user through audible sounds, created by a audible sound generator, when any one of the doors of the appliance is door is left open beyond a threshold duration (that is initially configured). The operation finally terminates at the end block 431, when the user responds to the alerting sounds and resets the wireless tracking device 309 (while also taking action to fix shut the door properly).

The power consumption monitoring device is capable of monitoring power consumption by a plurality of appliances electrically coupled to the power consumption monitoring device. A user can see the display of power consumption by each of the plurality of appliances. Displaying the list of the plurality of appliances is supported by the energy pump device using a display module provided by the energy pump device. The energy pump device is capable of showing the power usage computation for the plurality of appliances on the display module.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A method of reducing energy consumption of an appliance by modifying user behavior, the method comprising:
tracking an appliance usage information, by a tracking device located inside the appliance, wherein the tracking device is placed inside the appliance and wherein the tracking device is communicatively coupled to an external collector unit;
reporting, by the tracking device, the appliance usage information to the collector unit, wherein the collect unit is external to the appliance and is located in the same premises as the appliance;
correlating, by the collector unit, the number of times the appliance is used and the duration of such usage, with an energy consumption data computed or collected for the appliance;
making energy saving recommendations, by an advisory unit communicatively coupled to the collector unit and the tracking device, for efficient usage of the appliance.

2. The method of claim 1 wherein the appliance is a refrigerator that comprises at least one refrigerator door and wherein the tracking device tracks the closing and opening of the at least one refrigerator door, the number of times the at least one refrigerator door is opened, the duration for which it is opened, and the temperature inside the refrigerator at various times.

3. The method of claim 1 wherein the correlating unit and the advisory unit are combined into a power usage monitoring unit that is communicatively coupled to the tracking device while also being electrically coupled to the appliance via a smart power socket that is managed by the power usage monitoring unit.

4. The method of claim 1 wherein the tracking device is a wireless device comprising a processor circuitry, a radio frequency (RF) circuitry and memory, and communicates employing the RF circuitry, wherein the tracking operation conducted by the tracking device comprises:
sensing usage of the appliance by the tracking device by means of a light sensor and a temperature sensor; and
creating a sound to attract user attention, by the tracking device, for instructing the user on the operation of the appliance.

5. The method of claim 4 wherein the tracking device enables communication with a premises monitoring wireless infrastructure that monitors energy consumption by the appliance.

6. The method of claim 4 wherein the tracking device also comprises a light sensor component, the method further comprising:
entering a low power state, by the tracking device, with at least one of its components virtually turned off;
checking light by the light sensor component of the tracking device, periodically for changes;
taking a light reading, by the light sensor when it check periodically;
determining, by the tracking device, that the light reading exceeds a threshold value; and
gathering measurements.

7. An electronic device supporting tracking of usage of an appliance, the electronic device comprising:
a memory for storing data, code and instructions;
at least one temperature sensor to detect temperature;
at least one light sensor to detect light;
an RF circuitry for communication;
at least one processor communicatively coupled the RF circuitry to at least one data collector unit, the at least one processor operable to, at least:
monitor the operation of the appliance;
detect opening and closing of doors associated with the appliance and gather usage data;
collect sensor data provided by the at least one temperature sensor and the at least one light sensor; and
communicate sensor data and usage data to the at least one data collector unit.

8. The electronic device of claim 7 wherein the electronic device is designed to be located inside the appliance during normal operation.

9. The electronic device of claim 8 wherein the appliance is a refrigerator with a freezer unit.

10. The electronic device of claim 9 wherein the appliance comprises a refrigerator section with a refrigerator door and a freezer section with a freezer door and wherein the electronic device is capable of being used in either or both of the refrigerator section and the freezer section.

11. The electronic device of claim 10 further comprising:
the at least one processor operable to further, at least:
monitor duration for which the doors associated with the appliance are open;
monitor temperature changes during the period when the doors of the appliance are open; and
report the duration and temperature changes to the at least one data collector unit.

12. The electronic device of claim 10 further comprising:
an audible sound generator;
the at least one processor operable to further at least:
alert a user through audible sounds created by the audible sound generator when any one of the doors of the appliance is door is left open for a relatively long period of time based on a threshold value configured in the memory of the electronic device.

13. The electronic device of claim 8 wherein the electronic device provides data to the at least one data collector unit to facilitate computation of energy consumption by the appliance and energy wasted due to inappropriate usage of the appliance, and potential energy savings by proper usage of the appliance.

14. A wireless device that can collect data using sensors when located inside an appliance and communicate the data with an external data collector, the wireless device comprising:
a set of light sensors;
a set of temperature sensors;
a memory for storing data, code and instructions;
a RF circuitry for communication;
a processor communicatively coupled to the RF circuitry, the memory, the set of light sensors, the set of temperature sensors, and to the external data collector unit, the processor operable to, at least:
collect data using the set of light sensors and the set of temperature sensors when located inside the appliance;
detect when a door of the appliance is open or shut employing the set of light sensors;
detect the duration for which the appliance door is open;
detect temperature changes when the appliance door is open employing the set of temperature sensors;
process data collected by the set of light sensors and the set of temperature sensors; and
communicate data to the external data collector unit employing the RF circuitry.

15. The wireless device of claim 14 wherein the appliance is a refrigerator with a freezer section with a freezer door and a refrigeration section with a refrigeration door, wherein the wireless device is capable of being located and used in either of the sections.

16. The wireless device of claim 14 wherein the wireless device also comprises an audio component to produce sound and a replaceable battery component to provide battery power.

17. The wireless device of claim 14 wherein the processor communicates data to an existing wireless infrastructure employed in a premises, wherein the existing wireless infrastructure monitors appliance energy consumption.

18. The wireless device of claim 14 wherein the wireless device enters an extremely low power state with the processor and RF communication components virtually turned off, wherein the processor periodically checks the set of light sensors for changes and to detect a light reading that crosses a threshold value.

19. The wireless device of claim 15 the processor correlates the number of times and the duration for which the refrigerator door or the freezer door fridge door has been opened with an observed energy consumption data for the refrigerator to generate an estimate of an energy cost of opening the door of the refrigerator each time it is opened.

20. The wireless device of claim 15 facilitating determination of a usage pattern for the appliance and presenting recommendations for an appropriate temperature setting for the appliance.
